(19) United States
(12) Patent Application Publication
(10) Pub. No.: US 2025/0265481 A1
(43) Pub. Date: Aug. 21, 2025

(54) QUESTION ANSWERING SYSTEM USING GENERATIVE MODEL AND METHOD THEREOF

(71) Applicant: SAMSUNG SDS CO., LTD., Seoul (KR)

(72) Inventors: Jin Hyuk RYU, Seoul (KR); Kang Eui CHO, Seoul (KR); Jun Il KIM, Seoul (KR); Min Kee JUNG, Seoul (KR)

(73) Assignee: SAMSUNG SDS CO., LTD., Seoul (KR)

(21) Appl. No.: 19/056,482

(22) Filed: Feb. 18, 2025

(30) Foreign Application Priority Data
Feb. 21, 2024 (KR) 10-2024-0024866
Mar. 19, 2024 (KR) 10-2024-0037619

(51) Int. Cl. G06N 5/04; G06F 16/332

(52) U.S. Cl. CPC G06N 5/04; G06F 16/3325

(57) ABSTRACT

There is provided a question answering method and system thereof. The system may comprise one or more processors; and a memory storing one or more computer programs executed by the one or more processors, wherein the one or more computer programs include instructions for an operation of preprocessing a question of a user; an operation of obtaining a first candidate passage set associated with the preprocessed question by retrieving a knowledge base using a first embedding model; an operation of obtaining a second candidate passage set associated with the preprocessed question by retrieving the knowledge base using a second embedding model; an operation of extracting one or more common passages from the first candidate passage set and the second candidate passage set; and an operation of generating an answer to the preprocessed question from the one or more common passages through a generative model.

### CROSS-REFERENCE TO RELATED APPLICATIONS

This application claims priority from Korean Patent Application No. 10-2024-0024866 filed on Feb. 21, 2024, and Korean Patent Application No. 10-2024-0037619 filed on Mar. 19, 2024, in the Korean Intellectual Property Office, and all the benefits accruing therefrom under 35 U.S.C. 119, the contents of which in its entirety are herein incorporated by references.

### BACKGROUND

### 1. Technical Field

The present disclosure relates to a question answering system using a generative model (e.g., a large language model) and a method thereof.

### 2. Description of the Related Art

Question answering is a task in the field of natural language processing that generates an answer to a question (or a query) written in a natural language. Recently, researches into a method of performing question answering using a generative language model (e.g., a large language model) have been actively conducted, and companies that provide question answering services using the generative language model have also emerged one after another.

However, existing researches have a problem that an answer speed to each question is slow because they generate answers to all questions using the generative language model. In addition, the existing researches also have a problem that they provide only one answer to one question, such that cases where insufficient answers (information) are provided to users frequently occur. Moreover, the existing researches have a clear limitation in that they may not provide an answer to a special type of question, such as path finding.

### RELATED ART DOCUMENT

### Patent Document

Korean Patent No. 10-2391466 (published on Apr. 27, 2022)

### SUMMARY

Aspects of the present disclosure provide a system and method capable of generating an answer to a question (or a query) of a user using a generative model (e.g., a large language model).

Aspects of the present disclosure also provide a system and method capable of accurately generating an answer to a question.

Aspects of the present disclosure also provide a system and method capable of improving an answer speed to a question.

Aspects of the present disclosure also provide a system and method capable of accurately generating an answer to a special type of question (e.g., path finding, DB information retrieval, etc.).

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a question answering system. The system may comprise one or more processors; and a memory storing one or more computer programs executed by the one or more processors, wherein the one or more computer programs include instructions for an operation of preprocessing a question of a user; an operation of obtaining a first candidate passage set associated with the preprocessed question by retrieving a knowledge base using a first embedding model; an operation of obtaining a second candidate passage set associated with the preprocessed question by retrieving the knowledge base using a second embedding model; an operation of extracting one or more common passages from the first candidate passage set and the second candidate passage set; and an operation of generating an answer to the preprocessed question from the one or more common passages through a generative model.

In some embodiments, the first embedding model is trained using a text sample pair whose length difference is less than a reference value, and the second embedding model is trained using a text sample pair whose length difference is the reference value or more.

In some embodiments, the operation of preprocessing the question includes an operation of generating a prompt for augmenting the question based on a question answering history of the user and the question, and an operation of augmenting the question by inputting the prompt to a specific generative model.

In some embodiments, the operation of generating the answer to the preprocessed question includes an operation of obtaining surrounding passages associated with a first common passage of the one or more common passages, the surrounding passages being passages located around the first common passage in a document to which the first common passage belongs, and an operation of generating the answer to the preprocessed question by including the first common passage and the surrounding passages in the same prompt.

In some embodiments, the one or more common passages include a first common passage and a second common passage, and the operation of generating the answer to the preprocessed question includes an operation of generating a first prompt based on the preprocessed question and the first common passage, an operation of generating a first candidate answer to the preprocessed question by inputting the first prompt to the generative model, an operation of generating a second prompt based on the preprocessed question and the second common passage; and an operation of generating a second candidate answer to the preprocessed question by inputting the second prompt to the generative model.

In some embodiments, the operation of generating the answer to the preprocessed question includes an operation of generating a candidate answer to the preprocessed question by inputting a prompt generated based on the preprocessed question to the generative model, an operation of generating a verification prompt for verifying the candidate answer, an operation of verifying the candidate answer by inputting the verification prompt to a specific generative model, and an operation of providing the candidate answer as the answer to the preprocessed question based on a verification result.

In some embodiments, the knowledge base includes a drawing database (DB), and the one or more computer programs further include instructions for an operation of receiving another question related to path finding; an operation of obtaining analysis information of a drawing associated with another question by retrieving the drawing DB using another question, the analysis information including location information of elements of a space represented by the drawing and path information between the elements; an operation of generating a prompt based on another question and the analysis information; and an operation of deriving information related to the path finding by inputting the prompt to the generative model.

In some embodiments, the one or more computer programs further include instructions for an operation of receiving another question retrieving a document related to specific information; an operation of obtaining a passage associated with another question by retrieving the knowledge base using another question; an operation of generating a prompt based on meta information of a document to which another question and the obtained passage belong; and an operation of deriving information of the document related to the specific information by inputting the prompt to the generative model.

In some embodiments, the knowledge base includes a DB supporting query statement-based retrieval and a passage DB, and the one or more computer programs include further instructions for an operation of receiving another question requesting retrieval of specific information; an operation of generating a prompt for converting another question into a specific query statement based on another question, information of the DB, and a query statement example, the query statement example including a user question sample and a query statement sample corresponding to the user question sample; an operation of converting another question into the specific query statement by inputting the prompt to the generative model; and an operation of retrieving the DB using the specific query statement.

In some embodiments, the one or more computer programs further include instructions for an operation of obtaining a passage associated with another question by retrieving the passage DB using another question when the retrieval of the DB according to the specific query statement is unsuccessful; an operation of generating an additional prompt based on another question and the obtained passage; and an operation of generating an answer to another question by inputting the additional prompt to the generative model.

According to another aspect of the present disclosure, there is provided a question answering method performed by at least one processor. The method may comprise preprocessing a question of a user, obtaining a first candidate passage set associated with the preprocessed question by retrieving a knowledge base using a first embedding model, obtaining a second candidate passage set associated with the preprocessed question by retrieving the knowledge base using a second embedding model, extracting one or more common passages from the first candidate passage set and the second candidate passage set, and generating an answer to the preprocessed question from the one or more common passages through a generative model.

In some embodiments, the first embedding model is trained using a text sample pair whose length difference is less than a reference value, and the second embedding model is trained using a text sample pair whose length difference is the reference value or more.

In some embodiments, the preprocessing of the question includes generating a prompt for augmenting the question based on a question answering history of the user and the question, and augmenting the question by inputting the prompt to a specific generative model.

In some embodiments, the generating of the answer to the preprocessed question includes obtaining surrounding passages associated with a first common passage of the one or more common passages, the surrounding passages being passages located around the first common passage in a document to which the first common passage belongs, and generating the answer to the preprocessed question by including the first common passage and the surrounding passages in the same prompt.

In some embodiments, the one or more common passages include a first common passage and a second common passage, and the generating of the answer to the preprocessed question includes: generating a first prompt based on the preprocessed question and the first common passage; generating a first candidate answer to the preprocessed question by inputting the first prompt to the generative model; generating a second prompt based on the preprocessed question and the second common passage; and generating a second candidate answer to the preprocessed question by inputting the second prompt to the generative model.

In some embodiments, the generating of the answer to the preprocessed question includes generating a candidate answer to the preprocessed question by inputting a prompt generated based on the preprocessed question to the generative model, generating a verification prompt for verifying the candidate answer, verifying the candidate answer by inputting the verification prompt to a specific generative model, and

providing the candidate answer as the answer to the preprocessed question based on a verification result.

In some embodiments, the knowledge base includes a drawing DB, and the question answering method further comprises receiving another question related to path finding; obtaining analysis information of a drawing associated with another question by retrieving the drawing DB using another question, the analysis information including location information of elements of a space represented by the drawing and path information between the elements; generating a prompt based on another question and the analysis information; and deriving information related to the path finding by inputting the prompt to the generative model.

In some embodiments, the method may further comprise receiving another question retrieving a document related to specific information, obtaining a passage associated with another question by retrieving the knowledge base using another question, generating a prompt based on meta information of a document to which another question and the obtained passage belong, and deriving information of the document related to the specific information by inputting the prompt to the generative model.

In some embodiments, the knowledge base includes a DB supporting query statement-based retrieval and a passage DB, and the question answering method further comprises receiving another question requesting retrieval of specific information; generating a prompt for converting another question into a specific query statement based on another question, information of the DB, and a query statement example, the query statement example including a user question sample and a query statement sample corresponding to the user question sample; converting another question into the specific query statement by inputting the prompt to the generative model; and retrieving the DB using the specific query statement.

According to still another aspect of the present disclosure, there is provided a computer program stored in a computer-readable recording medium coupled to a processor of a computer to execute preprocessing a question of a user, obtaining a first candidate passage set associated with the preprocessed question by retrieving a knowledge base using a first embedding model, obtaining a second candidate passage set associated with the preprocessed question by retrieving the knowledge base using a second embedding model, extracting one or more common passages from the first candidate passage set and the second candidate passage set, and generating an answer to the preprocessed question from the one or more common passages through a generative model.

According to some exemplary embodiments of the present disclosure, a first candidate passage set may be obtained by retrieving a knowledge base using a first embedding model, and a second candidate passage set may be obtained by retrieving the knowledge base using a second embedding model. In addition, one or more common passages may be extracted from the first candidate passage set and the second candidate passage set, and an answer to a question (or a query) of a user may be generated from the one or more common passages through a generative model. In such a case, a passage associated with the question may be more accurately retrieved, and consequently, the answer to the question may also be more accurately generated. Furthermore, as the number of retrieved passages (i.e., common passages) is reduced, a computing cost required for answer generation is reduced and an answer speed to the question may be improved.

In addition, the first embedding model may be constructed through training based on a text sample pair whose length difference is less than a reference value, and the second embedding model may be constructed through training based on a text sample pair whose length difference is the reference value or more. In such a case, even when passages having various lengths exist in the knowledge base (i.e., a passage DB), passages associated with the question may be accurately retrieved.

In addition, a prompt for generating the answer may be generated (configured) by further using surrounding passages of the common passage in addition to the common passage (or a general passage). In such a case, the probability that information (e.g., the correct answer) associated with the question will be included in the prompt may increase, and even when the information spans several passages, the answer may be accurately generated.

In addition, multiple prompts may be generated using multiple common passages (or general passages), and multiple candidate answers may be generated using the multiple prompts. In such a case, a rich answer to the question may be easily provided to the user.

In addition, by including drawing analysis information (e.g., location information of space elements and path information between the space elements, etc.) in a prompt, an answer to a path finding type of question may also be accurately generated through the generative model.

Further, by including meta information of a document to which a passage associated with a question belongs in a prompt, an answer to a document retrieval type of question (e.g., a question requesting the retrieval of a document that is a source of a specific document) may also be accurately generated through the generative model.

Further, by converting an information retrieval type of question (e.g., a question requesting the retrieval of specific information) into a query statement through the generative model and retrieving specific DB using the query statement, an answer to the information retrieval type of question may also be accurately generated.

Further, by including a query statement example in a prompt for query statement conversion, the question (i.e., the information retrieval type of question) of the user may be accurately converted into a query statement.

Moreover, by including an instruction requesting an explanation for the reason for conversion in the prompt for query statement conversion, accuracy of query statement conversion may be further improved.

The effects according to the technical spirit of the present disclosure are not limited to the aforementioned effects, and various other effects may be obviously understood by one of ordinary skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail embodiments thereof with reference to the attached drawings, in which:

FIGS. 1 and 2 are illustrative diagrams for describing an operation of a question answering system according to some exemplary embodiments of the present disclosure at a system level;

FIG. 3 is an illustrative diagram illustrating an overall process in which the question answering system according to some exemplary embodiments of the present disclosure generates an answer to a question of a user;

FIG. 4 is an illustrative flowchart illustrating a question answering method according to some exemplary embodiments of the present disclosure;

FIGS. 5 and 6 are illustrative diagrams for describing, in detail, constructing a knowledge base illustrated in FIG. 4;

FIG. 7 is an illustrative diagram for describing, in detail, preprocessing a question illustrated in FIG. 4;

FIG. 8 is an illustrative flowchart illustrating detailed processes of generating an answer illustrated in FIG. 4;

FIG. 9 is an illustrative flowchart illustrating an answer generation method according to some exemplary embodiments of the present disclosure;

FIG. 10 is an illustrative diagram for describing, in detail, extracting a common passage illustrated in FIG. 9;

FIG. 11 is an illustrative diagram for describing characteristics and a training method of a first embedding model and a second embedding model according to some exemplary embodiments of the present disclosure;

FIG. 12 is an illustrative flowchart illustrating detailed processes of generating an answer illustrated in FIG. 9;

FIGS. 13 to 15 are illustrative diagrams for describing, in detail, verifying a candidate answer illustrated in FIG. 12;

FIG. 16 is a diagram illustrating a process of generating multiple candidate answers according to some exemplary embodiments of the present disclosure;

FIG. 17 is an illustrative diagram for describing an answer generation method according to some other exemplary embodiments of the present disclosure;

FIG. 18 is an illustrative diagram for describing an answer generation method according to some other exemplary embodiments of the present disclosure;

FIG. 19 is an illustrative diagram for describing an answer generation method according to some other exemplary embodiments of the present disclosure; and

FIG. 20 is a diagram illustrating an illustrative computing device capable of implementing a question answering system according to some exemplary embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

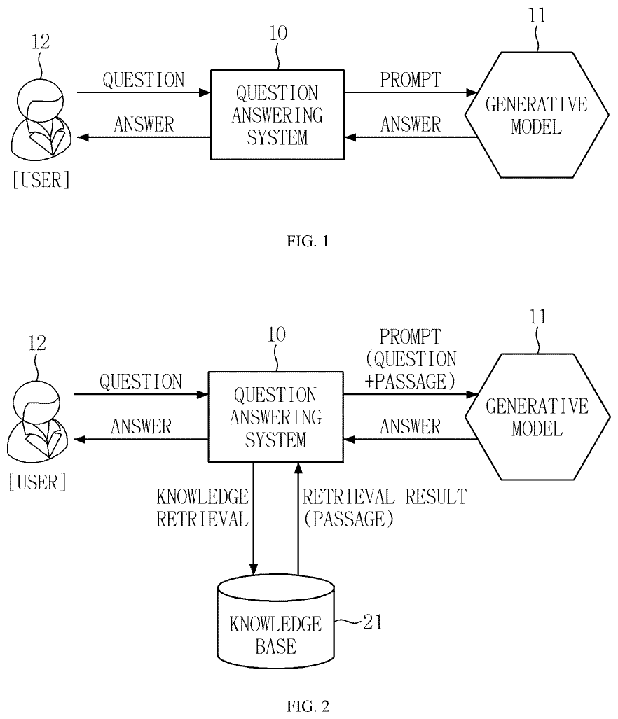

FIGS. 1 and 2 are illustrative diagrams for describing an operation of a question answering system 10 according to some exemplary embodiments of the present disclosure at a system level.

As illustrated in FIG. 1 and the like, the question answering system 10 is a computing device/system that may generate an answer to a question (or a query) of a user 12 using a generative model 11. For example, the question answering system 10 may generate the answer to the question of the user 12 by generating (configuring) a prompt based on the question of the user 12 and inputting the prompt to the generative model 11. In addition, the question answering system 10 may provide the generated answer to the user 12. The question answering system 10 may also provide a question answering service to multiple users.

The generative model 11 refers to a deep-learning model that has a capability to understand and generate a natural language (text). Examples of such a deep-learning model may include a large language model, but the scope of the present disclosure is not limited thereto. In some cases, the generative model 11 may be a visual language model (or a large multi-modal model) that further has a capability to understand an image (or a capability to understand and generate an image).

The generative model 11 may be a model developed autonomously or a model provided externally. The generative model 11 may collectively refer to multiple generative models.

For reference, the term ‘question’ may be named as a ‘query’, a ‘problem’, or the like, in some cases.

In addition, the term ‘answer’ may be named as a ‘response’, a ‘solution’, a ‘reply or response’, or the like, in some cases.

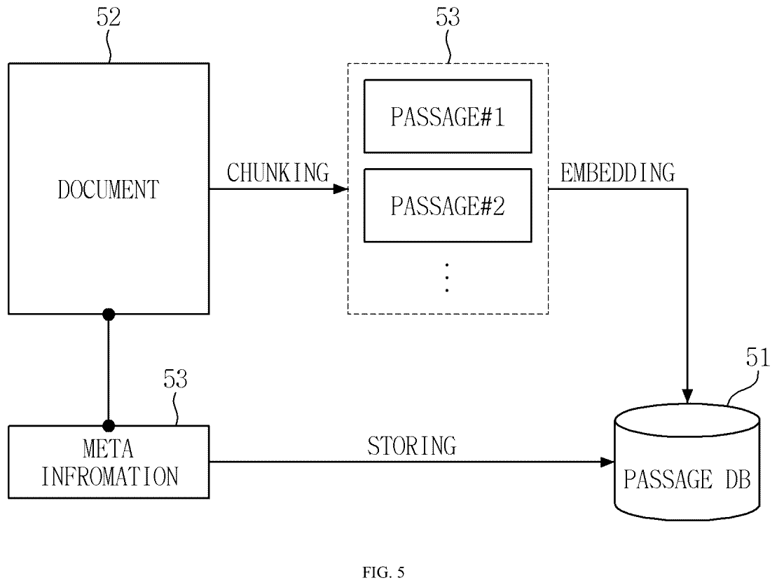

As illustrated in FIG. 2, the question answering system 10 may use a knowledge base 21 in order to provide an answer function to a special type of question (e.g., a path finding-related question, etc.) and improve answer generation accuracy of the generative model 11. Here, the knowledge base 21 may refer to a repository where knowledge of various domains is stored. The knowledge base 21 may include, for example, a passage database (DB), a drawing DB providing drawing analysis information, a document DB, and the like. However, the scope of the present disclosure is not limited thereto. In some cases, the knowledge base 21 may further include various information DBs that support query statement-based retrieval (e.g., a relational DB that supports structured query language (SQL) retrieval, etc.). A method of constructing such a knowledge base 21 will be described later with reference to FIGS. 4 to 6 and the like.

Specifically, the question answering system 10 may obtain various knowledge associated with the question by retrieving the knowledge base 21 using the question of the user 12. In addition, the question answering system 10 may generate an answer to the question using the obtained knowledge.

For example, the question answering system 10 may obtain passages associated with a question (e.g., top-K passages having high vector similarity, etc.) by retrieving the passage DB of the knowledge base 21 (e.g., performing vector retrieval). In addition, the question answering system 10 may generate the answer to the question by generating (configuring) a prompt based on the question of the user 12 and the passages and inputting the prompt to the generative model 11. Here, inputting the prompt to the generative model 11 may encompass a concept of transmitting the prompt to the generative model 11.

In some cases, the question answering system 10 may generate the answer to the question using knowledge retrieved from the knowledge base 21 without using the generative model 11 (e.g., when a question requesting a summary of a specific document is received and an abstract of the specific document is stored in the knowledge base 21, the question answering system 10 may provide the abstract of the specific document to the user as it is).

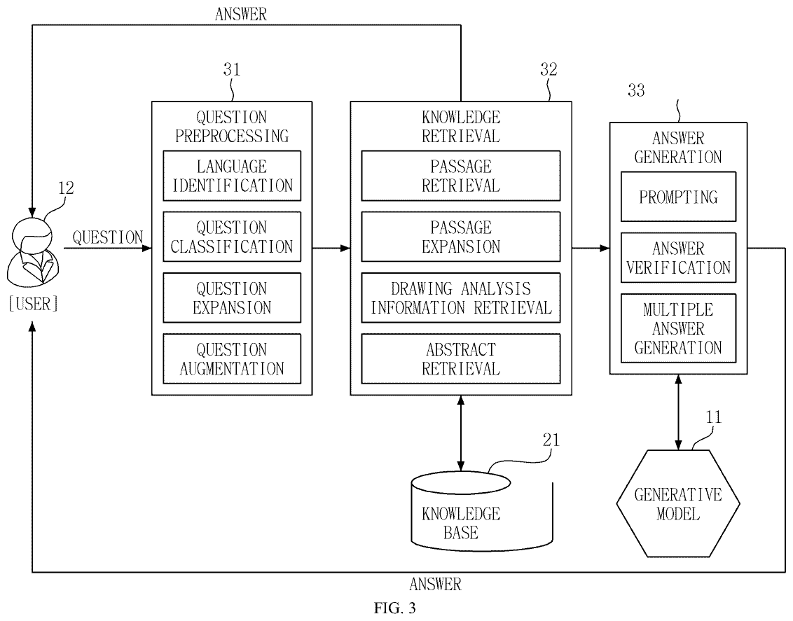

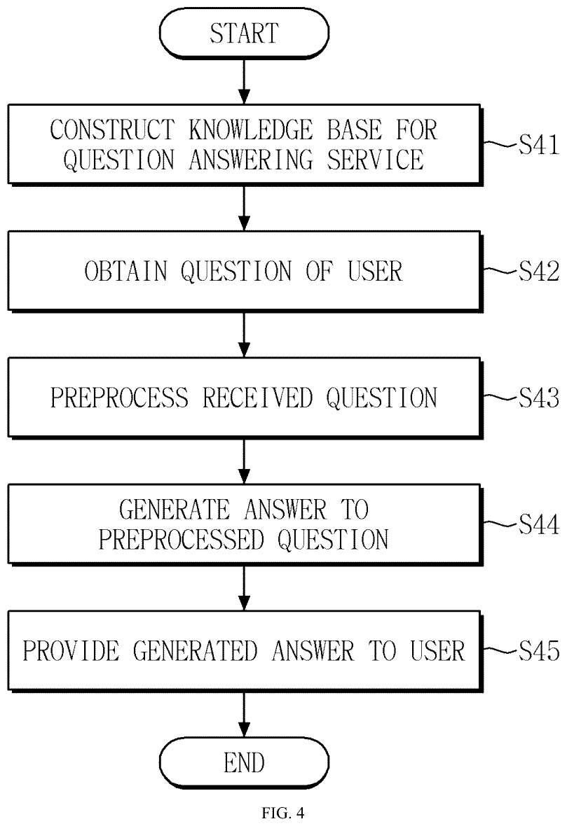

FIG. 3 illustrates, in more detail, an overall process in which the question answering system 10 generates an answer to a question of the user 12. Blocks (e.g., 31 to 33) illustrated in FIG. 3 may be understood to refer to modules (or functional blocks) constituting the question answering system 10.

As illustrated in FIG. 3, the question answering system 10 may generate the answer to the question of the user 12 by sequentially performing a question preprocessing process 31, a knowledge retrieval process 32, and an answer generation process 33.

In the question preprocessing process 31, the question answering system 10 may perform preprocessing such as language identification of the question (and question expansion), type classification of the question, question expansion (e.g., addition of a synonym, addition of a question of another language, addition of a full term corresponding to an abbreviation, etc.), and question augmentation (e.g., augmentation of a current question based on a question answering history). Such a preprocessing process 31 will be described in more detail later with reference to FIG. 4 and the drawings after FIG. 4.

In the knowledge retrieval process 32, the question answering system 10 may retrieve a passage from the knowledge base 21 (i.e., the passage DB) using the preprocessed question (or original question). The question answering system 10 may further retrieve passages located around the retrieved passage (i.e., passages located around the retrieved passage in the same document) (see ‘passage expansion’). Alternatively, the question answering system 10 may retrieve drawing analysis information from the knowledge base 21 (i.e., the drawing DB) in order to process a special type of question such as path finding. Alternatively, the question answering system 10 may retrieve an abstract of a specific document from the knowledge base 21 (e.g., the passage DB, the document DB, etc.) (e.g., when a question requesting a summary of the specific document is received). Such a knowledge retrieval process 32 will be described in more detail later with reference to FIG. 4 and the drawings after FIG. 4.

In the answer generation process 33, the question answering system 10 may generate the answer to the question by generating (configuring) a prompt based on the retrieved knowledge and the question and inputting the prompt to the generative model 11. In this case, the question answering system 10 may generate multiple candidate answers to one question in order to provide a richer answer to the user 12 (see ‘multiple answer generation’). In addition, the question answering system 10 may perform verification for the generated answer for answer accuracy (e.g., in order to prevent a hallucination problem). Such an answer generation process 33 will be described in more detail later with reference to FIG. 4 and the drawings after FIG. 4.

As illustrated in FIG. 4, the question answering system 10 may generate (derive) the answer to the question of the user 12 through the knowledge retrieval process 32 without using the generative model 11. As an example, the question answering system 10 may store an answer to a question having a high occurrence frequency (e.g., an answer generated by the generative model 11) in the knowledge base 21, and may retrieve and provide the answer stored in the knowledge base 21 when the corresponding question is received again As another example, when a question requesting a summary of a specific document is received and an abstract of the specific document is stored in the knowledge base 21, the question answering system 10 may retrieve the abstract of the specific document and provide the retrieved abstract to the user. In such a case, the answer is provided to the user without going through the generative model 11, and thus, an answer speed to the question may be significantly improved.

The question answering system 10 described above may be implemented as at least one computing device. For example, all functions of the question answering system 10 may be implemented in one computing device or a first function of the question answering system 10 may be implemented in a first computing device and a second function of the question answering system 10 may be implemented in a second computing device. Alternatively, specific functions of the question answering system 10 may be implemented in a plurality of computing devices.

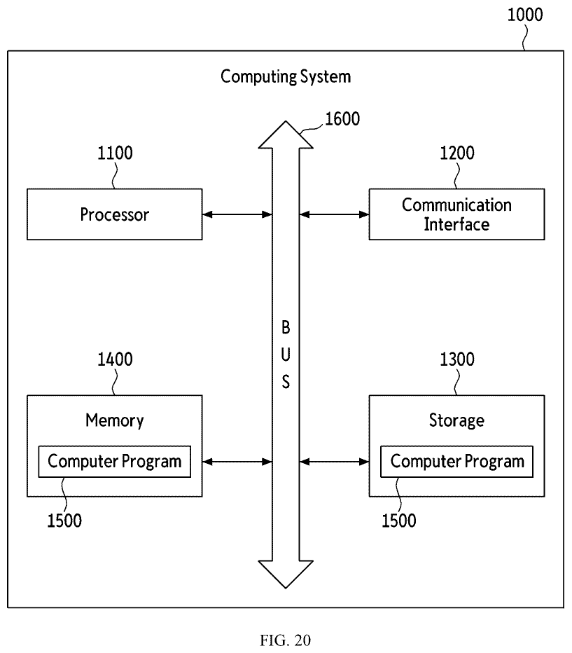

The computing device may include any device having a computing/processing function, and reference is made to FIG. 20 in relation to an example of such a device. The computing device is an aggregate of various components (e.g., a memory, a processor, etc.) interacting with each other, and may thus be referred to as a ‘computing system’ in some cases. The term ‘computing system’ may also encompass a concept of an aggregate of a plurality of computing devices interacting with each other.

So far, the operation of the question answering system 10 according to some exemplary embodiments of the present disclosure has been schematically described with reference to FIGS. 1 to 3. Hereinafter, various methods that may be performed in the question answering system 10 described above will be described with reference to FIG. 4 and the drawings after FIG. 4.

At least some of steps/operations of methods to be described later may be performed by the question answering system 10 having at least one processor. Hereinafter, in order to provide convenience of understanding, a description will be provided on the assumption that all steps/operations of methods to be described later are performed by the question answering system 10 described above. Accordingly, when a subject of a specific step/operation is omitted, it may be understood that the specific step/operation is performed by the question answering system 10. However, in a real environment, some steps/operations of methods to be described later may be performed by another computing device/system. Hereinafter, for convenience of explanation, the question answering system 10 will be abbreviated as a ‘system 10’.

FIG. 4 is an illustrative flowchart illustrating a question answering method according to some exemplary embodiments of the present disclosure. However, this is only an exemplary embodiment for achieving an object of the present disclosure, and some steps may be added or deleted, if necessary.

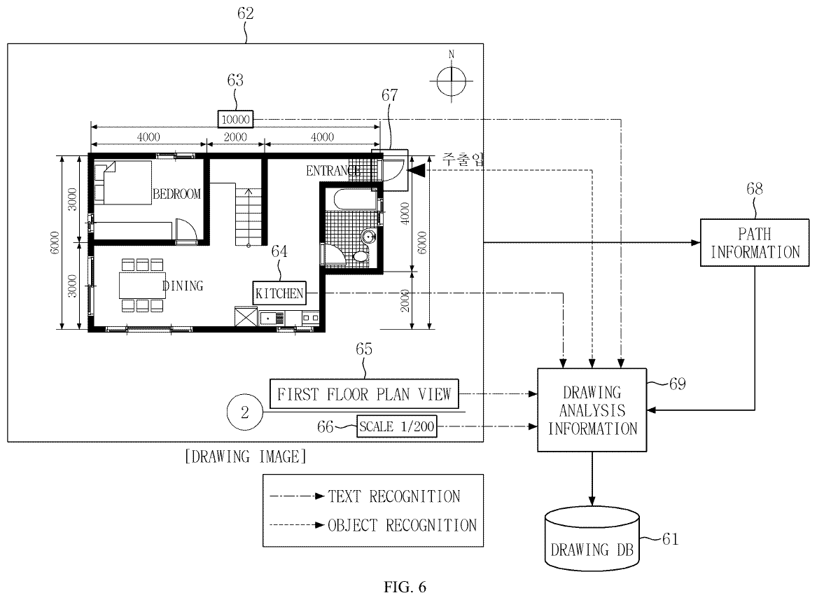

As illustrated in FIG. 4, the question answering method according to exemplary embodiments may start at constructing the knowledge base 21 for a question answering service (S41). As described above, the knowledge base 21 may include a passage DB 51 (see FIG. 5), a drawing DB 61 (see FIG. 6), and a document DB, and may further include various information DBs that support query statement-based retrieval.

As an example, the system 10 may construct the passage DB 51 (see FIG. 5) by chunking various documents. Such an example will be described in more detail later with reference to FIG. 5.

As another example, the system 10 may construct the drawing DB 61 (see FIG. 6) by analyzing various drawing images. Such an example will be described in more detail later with reference to FIG. 6.

As still another example, the system 10 may construct the document DB by storing various documents and meta information of the various documents together. The meta information of the document may include, for example, a title, a writer, a generation date, a modification date, a file format, a size, a table of contents, an abstract, a passage location, and the like. However, the scope of the present disclosure is not limited thereto. The abstract of the meta information may be used as an answer to a question requesting a summary of a specific document.

Hereinafter, the examples described above will be described in detail with reference to FIGS. 5 and 6.

FIG. 5 illustrates a process of constructing the passage DB 51.

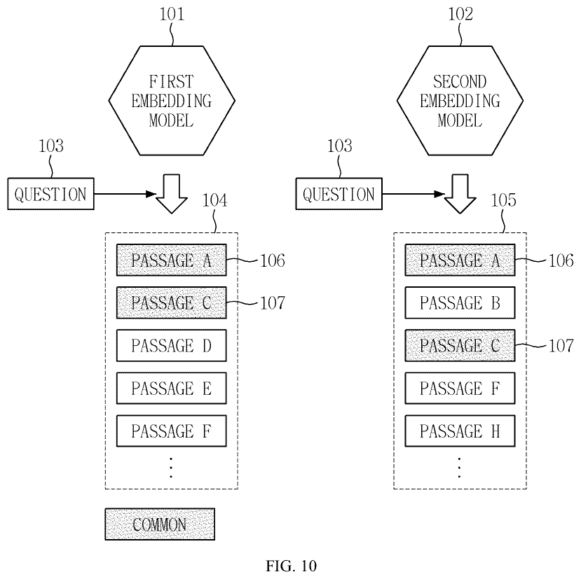

As illustrated in FIG. 5, the system 10 may generate a plurality of passages 53 by chunking a document 52 and store each of the passages 53 in the passage DB 51 in a state in which the system 10 matches each of the passages 53 to a passage embedding vector (i.e., the passage DB 51 is a DB that supports vector retrieval). In this case, the system 10 may generate one passage embedding vector for each passage using one embedding model or generate multiple passage embedding vectors for each passage using multiple embedding models (e.g., embedding models 101 and 102 (see FIG. 10)). For reference, the term ‘embedding vector’ may be abbreviated as ‘embedding’ in some cases.

The system 10 may or may not chunk the document 52 at a fixed length (however, even though the document 52 is chunked at a fixed length, lengths of the passages may be different from each other). A method of chunking the document 52 may be any method.

In addition, the system 10 may store meta information 54 of the document 52 together in the passage DB 51. As described above, the meta information 54 of the document 52 may include, for example, a title, a writer, a generation date, a modification date, a file format, a size, a table of contents, an abstract, a passage location (e.g., a page number in the document, etc.), and the like. However, the scope of the present disclosure is not limited thereto.

The system 10 may construct the passage DB 51 by repeatedly performing the above-described processes on various documents.

FIG. 6 illustrates a process of constructing the drawing DB 61.

As illustrated in FIG. 6, the system 10 may generate drawing analysis information 69 by extracting and analyzing various information from a drawing image 62. In addition, the system 10 may store the drawing analysis information 69 in the drawing DB 61. Here, a drawing may be understood as a concept encompassing a design drawing, a map, and the like.

Specifically, the system 10 may extract information on space elements constituting a space (place) represented by the drawing from the drawing image 62. Here, the space elements may be understood as encompassing specific points (e.g., an entrance), zones (e.g., a bedroom, a kitchen, a dining room, etc.) of the space. For example, the system 10 may extract information (e.g., type, location, etc.) of space elements (e.g., 67) from the drawing image 62 using an object detection model trained using drawing components (e.g., components representing space elements such as a door and a stair). In addition, the system 10 may extract information (e.g., type, location, etc.) of a name 65, a scale 66, a numerical value 63, and space elements of the space (place) from the drawing image 62 using a text recognition model. The system 10 may calculate a size of the space elements (e.g., a size of a zone), a distance between the space elements, and the like, by analyzing the scale 66, the numerical value 63, and the like.

In addition, the system 10 may also derive path information 68 (e.g., the shortest path, a main path, etc.) between space elements (e.g., 64 and 67) using a path search algorithm. For example, the system 10 may derive the shortest path between the space elements using a shortest path algorithm (e.g., a Dijkstra's algorithm, etc.). Alternatively, the system 10 may generate a spanner graph having the space elements as vertices using a greedy geometric spanner algorithm and derive all paths between the space elements using the spanner graph.

The system 10 may store the drawing analysis information 69 including the information of the space elements extracted from the drawing image 66 and the path information 68 in the drawing DB 61.

The system 10 may construct the drawing DB 61 by repeatedly performing the above-described processes on various drawing images.

So far, the processes of constructing the passage DB 51 and the drawing DB 61 have been described in detail with reference to FIGS. 5 and 6.

A description will be provided with reference to FIG. 4 again.

In S42, a question of the user is obtained. For example, the system 10 may receive the question from the user. Here, receiving the question from the user may encompass a concept in which the system 10 receives the question from a user terminal. A method in which the system 10 obtains the question may be any method.

In S43, the received question is preprocessed. The system 10 may preprocess the received question in various manners.

As an example, the system 10 may identify a language of the question and add a question of another language based on an identification result. For example, when a Korean question (or an English question) is received, the system 10 may add an English question (or a Korean question) corresponding to the Korean question (or the English question) to the received question.

As another example, the system 10 may add a full term corresponding to an abbreviation in the question to the question (or replace the abbreviation with the full term) with reference to a glossary that is prepared in advance. Alternatively, the system 10 may retrieve a synonym for a specific word in the question with reference to the glossary and add the synonym to the question.

As still another example, the system 10 may classify a type (or a task) of the received question. The type of the question may be defined as, for example, a general type (i.e., a general QA type), a document retrieval type, a path finding type, a document summary type, an information retrieval type, or the like, but the scope of the present disclosure is not limited thereto. Here, the document retrieval type refers to a type related to a question that requests retrieval of a document related to specific information (e.g., a question that requests retrieval of a document that is a source of the information), and the path finding type refers to a type of a question related to path finding. In addition, the document summary type refers to a type related to a question that requests a summary of a specific document (however, a question that requests a summary for a document for which an abstract does not exist in document meta information or a question that requests a summary of an input text may correspond to the general type), and the information retrieval type refers to a type related to a question that requests retrieval of specific information. The system 10 may classify the type of the question using a specific generative language model (e.g., input a prompt including predefined question type information, a received question, and an instruction requesting question type classification to the generative language model 11), but the scope of the present disclosure is not limited thereto.

For reference, a generative model used for question type classification may be the same model as or a different model from the generative model 11 used for answer generation. Such technical contents may also be applied to a case where other tasks (e.g., question augmentation, answer verification, etc.) other than question answering are performed using the generative model (i.e., different generative models may be used for each task or the same generative model 11 may be used for each task). However, hereinafter, in order to provide convenience of understanding, a description will be provided on the assumption that all tasks are performed using the generative model 11.

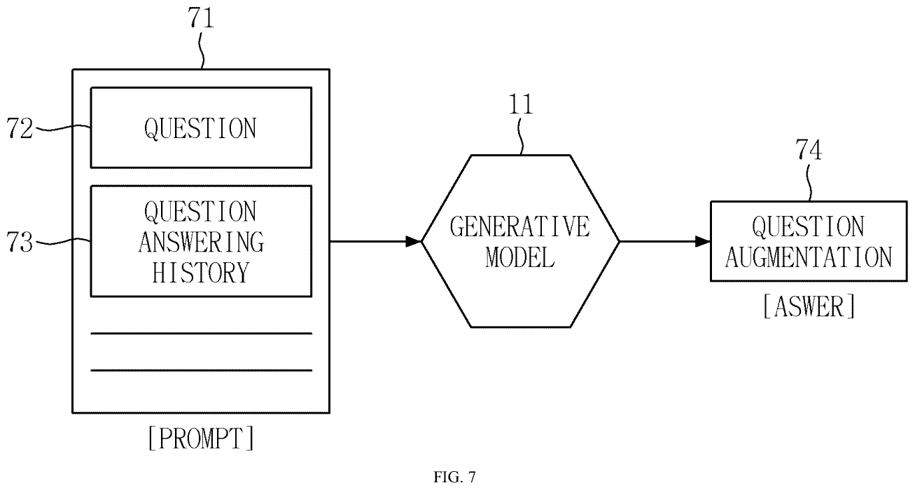

As still another example, the system 10 may augment the received question based on a question answering history of the user. For example, as illustrated in FIG. 7, the system 10 may augment a question 72 (see 74) by generating (configuring) a prompt 71 based on a question answering history 73 of the user and the received question 72 (e.g., inserting the question answering history 73 and the question 72 into a prompt template that is prepared in advance) and inputting the prompt 71 to the generative model 11. The prompt 71 may include an instruction requesting question augmentation, and may further include other contents (information). According to an example of FIG. 7, a current question 72 of the user may be accurately augmented through the generative model 11 that may understand the question answering history 73 (i.e., a context). The question answering history may be named as a ‘dialog history’ in some cases.

As still another example, the system 10 may preprocess the received question based on various combinations of the examples described above.

A description will be provided with reference to FIG. 4 again.

In S44, an answer to the preprocessed question is generated. For example, the system 10 may generate a preset number of candidate answers (e.g., one candidate answer, multiple candidate answers, etc.) through the generative model 11. Here, the number of candidate answers may be set by the user (e.g., when the user specifies the number of candidate answers in the question) or may be a setting value of the system 10. In some cases, the system 10 may generate the answer (or the candidate answer) without going through the generative model 11.

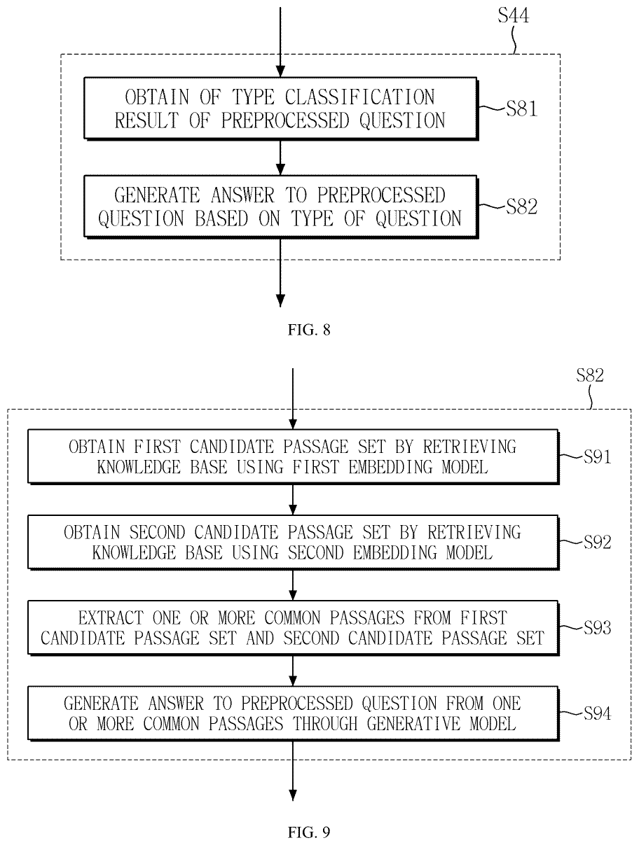

Detailed processes of S44 will be described in more detail later with reference to FIGS. 8 to 19.

In S45, the generated answer is provided to the user. For example, the system 10 may provide a preset number of candidate answers to the user (e.g., transmit the preset number of candidate answers to the user terminal).

Hereinafter, detailed processes of generating the answer (S44) described above will be described in detail with reference to FIGS. 8 to 19.

FIG. 8 is an illustrative flowchart illustrating detailed processes of generating an answer (S44). However, this is only an exemplary embodiment for achieving an object of the present disclosure, and some steps may be added or deleted, if necessary.

As illustrated in FIG. 8, an answer to the preprocessed question is generated based on the type of the question (S81 and S82). For example, the system 10 may generate the answer to the preprocessed question in at least partial different manners depending on the type of the question. As described above, the type of the question may be defined as, for example, a general type, a document retrieval type, a path finding type, a document summary type, an information retrieval type, or the like, but the scope of the present disclosure is not limited thereto.

Hereinafter, a specific method of generating answers to various types of questions as described above will be described.

First, an answer generation method according to some exemplary embodiments of the present disclosure will be described with reference to FIGS. 9 to 16. An answer generation method to be described later is a method of generating an answer to a ‘general type’ of question. However, technical contents included in an answer generation method to be described later may also be applied to other types of questions.

FIG. 9 is an illustrative flowchart illustrating an answer generation method according to some exemplary embodiments of the present disclosure. However, this is only an exemplary embodiment for achieving an object of the present disclosure, and some steps may be added or deleted, if necessary.

As illustrated in FIG. 9, the present exemplary embodiments relate to a method of generating an answer to a preprocessed question (i.e., a general type of question) through knowledge retrieval based on a plurality of embedding models. FIG. 9 illustrates a case where two embedding models are used, but the scope of the present disclosure is not limited thereto. In some cases, three or more embedding models may be used for knowledge retrieval.

Specifically, the present exemplary embodiments may start at obtaining a first candidate passage set by retrieving the knowledge base 21 using a first embedding model 101 (see FIG. 10) S91. For example, as illustrated in FIG. 10, the system 10 may generate an embedding vector for a preprocessed question 103 through the first embedding model 101 and retrieve the passage DB 51 using the embedding vector (i.e., perform retrieval based on vector similarity). As a result, the system 10 may obtain a first candidate passage set 104 including top-K passages (e.g., 106 and 107) (here, K is a natural number of 1 or more) having high vector similarity.

In S92, a second candidate passage set is obtained by retrieving the knowledge base 21 using a second embedding model 102 (see FIG. 10). For example, as illustrated in FIG. 10, the system 10 may generate an embedding vector for the preprocessed question 103 through the second embedding model 102 and retrieve the passage DB 51 using the embedding vector (i.e., perform retrieval based on vector similarity). As a result, the system 10 may obtain a second candidate passage set 105 including top-M passages (e.g., 106 and 107) (here, M is a natural number of 1 or more) having high vector similarity. The number of passages in the first candidate passage set 104 may be the same as or different from the number of passages in the second candidate passage set 105.

In S93, one or more common passages are extracted from the first candidate passage set and the second candidate passage set. For example, as illustrated in FIG. 10, the system 10 may extract passages (e.g., 106 and 107) that exist in common in the first candidate passage set 104 and the second candidate passage set 105. In this way, passages associated with the question 103 may be more accurately retrieved (determined). Furthermore, as the number of passages input to the generative model 11 is reduced, a computing cost required for answer generation may be reduced and an answer speed may be improved.

The first embedding model 101 may be a model suitable for deciding similarity (i.e., embedding similarity) between texts between which a length difference is relatively small, and the second embedding model 102 may be a model suitable for deciding similarity between texts between which a length difference is relatively great. Such a first embedding model 101 may be constructed through training based on a text sample pair whose length difference is less than a reference value (e.g., training based on a contrastive learning task), and such a second embedding model 102 may be constructed through training based on a text sample pair whose length difference is a reference value or more.

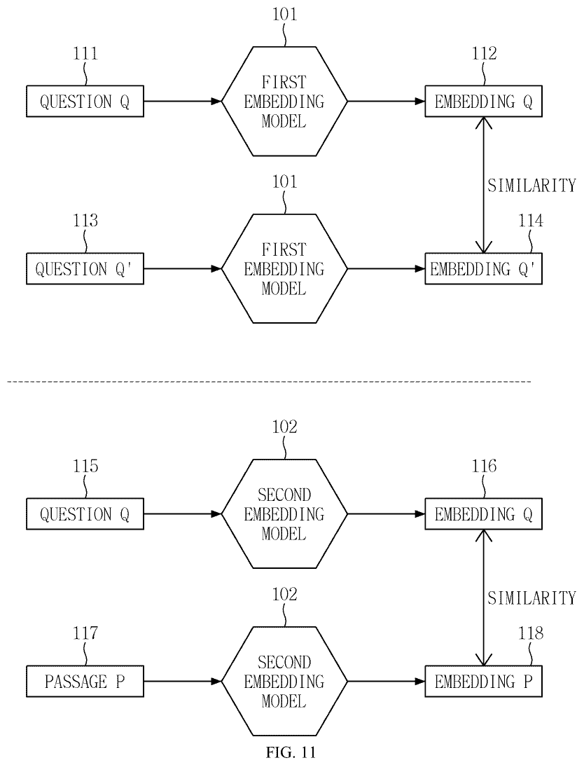

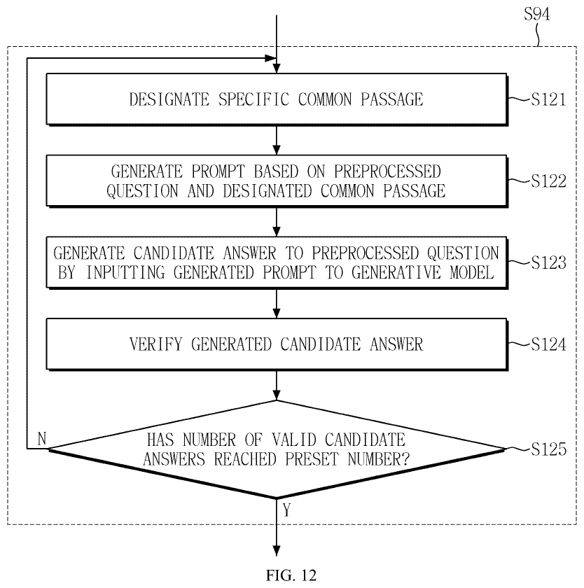

As a more specific example, as illustrated in FIG. 11, the first embedding model 101 may be trained using a question sample pair 111 and 113 having a similar length. When the question sample pair 111 and 113 is a positive pair, parameters of the first embedding model 101 may be updated in a direction in which similarity between embedding vectors 112 and 114 increases. Otherwise (i.e., when the question sample pair 111 and 113 is a negative pair), the parameters of the first embedding model 101 may be updated in a direction in which the similarity between the embedding vectors 112 and 114 decreases. In FIG. 11, lengths of question and passage figures refer to lengths of a question and a passage.

In addition, for example, as illustrated in FIG. 11, the second embedding model 102 may be trained using a question-passage sample pair 115 and 117 having different lengths. When the question-passage sample pair 115 and 117 is a positive pair, parameters of the second embedding model 102 may be updated in a direction in which similarity between embedding vectors 116 and 118 increases. Otherwise (i.e., when the question-passage sample pair 115 and 117 is a negative pair), the parameters of the second embedding model 102 may be updated in a direction in which the similarity between the embedding vectors 116 and 118 decreases.

When the two embedding models 101 and 102 as described above are used, passages associated with the question may be accurately retrieved even when passages having various lengths exist in the passage DB 51.

A description will be provided with reference to FIG. 9 again.

In S94, an answer to the preprocessed question is generated from one or more common passages through the generative model 11. For example, the system 10 may generate a preset number of candidate answers by generating one or more prompts based on one or more common passages, the preprocessed question, a related instruction, and the like, and inputting the one or more prompts to the generative model 11. In this case, the system 10 may also generate a prompt by further using surrounding passages of the common passage (i.e., passages located around the common passage in the same document). Reference is made to a description of FIGS. 12 to 16 in relation to this. In addition, the system 10 may verify the answer (or the candidate answer) through the generative model 11. Reference is made to a description of FIGS. 12 to 16 in relation to this.

Hereinafter, S94 will be described in detail with reference to FIGS. 12 to 16.

FIG. 12 is an illustrative flowchart illustrating detailed processes of generating an answer (S94). However, this is only an exemplary embodiment for achieving an object of the present disclosure, and some steps may be added or deleted, if necessary. Next, a description will be provided with reference to FIG. 12.

In S121, a specific common passage is designated. For example, the system 10 may preferentially designate a common passage having high vector similarity, but the scope of the present disclosure is not limited thereto.

In S122, a prompt is generated (configured) based on the preprocessed question and the designated common passage. For example, the system 10 may generate the prompt so as to include the designated common passage, the preprocessed question and a related instruction, meta information of the common passage (e.g., meta information of a document to which the common passage belongs, a page number of the common passage, etc.), and the like.

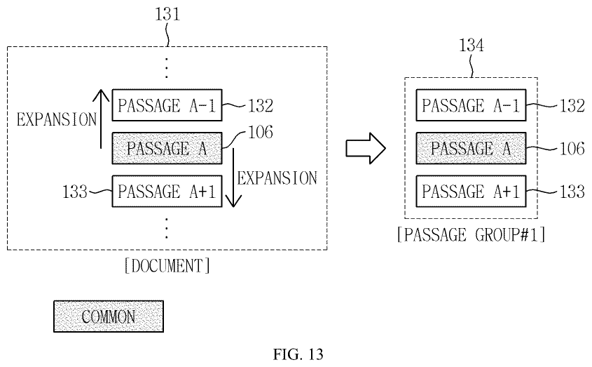

In some exemplary embodiments, the prompt may be generated further based on the surrounding passages of the designated common passage. For example, as illustrated in FIG. 13, the system 10 may obtain surrounding passages 132 and 133 of a common passage 106 from the passage DB 51 and group the surrounding passages 132 and 133. Here, the surrounding passage (e.g., 132) refers to a passage located around the common passage 106 in a document 131 to which the common passage 106 belongs. FIG. 13 assumes that the number of surrounding passages grouped together with the common passage 106 is ‘2’. Next, the system 10 may generate a prompt so that a passage group 134 is included in the same prompt (i.e., the common passage 106 and the surrounding passages 132 and 133 are included in one prompt). The reason why such a passage expansion process is performed may be understood as to increase the probability of finding information (e.g., a correct answer) associated with the question and allow an accurate answer to be generated even when the information spans several passages. In the drawings after FIG. 13, ‘passage A−1’ refers to an immediately previous passage of passage A, and ‘passage A+1’ refers to the next passage of passage A.

In the previous exemplary embodiments, the number of surrounding passages (e.g., 132) may be a preset fixed value or a value changed depending on a situation. For example, the number of surrounding passages (e.g., 132) may be determined based on a maximum number of tokens set in the generative model 11. Here, the maximum number of tokens may refer to a maximum limit for the sum of the number of input tokens (i.e., the number of tokens of the prompt) and the number of output tokens (i.e., the number of tokens of the answer) of the generative model 11. As a more specific example, the system 10 may calculate the allowable number of tokens of the prompt by subtracting the preset number of answer tokens (e.g., set to an appropriately great value) from the maximum number of tokens, and calculate the number of tokens allocatable to the surrounding passages by subtracting the number of tokens of the common passage (e.g., 106), the preprocessed question, and other instructions from the allowable number of tokens. Next, the system 10 may calculate the number of surrounding passages for the common passage (e.g., 106) based on the number of tokens allocatable to the surrounding passages (e.g., divide the number of tokens allocatable to the surrounding passages by a fixed chunking length (or a maximum passage length)).

A description will be provided with reference to FIG. 12 again.

In S123, a candidate answer to the preprocessed question is generated by inputting the generated prompt to the generative model 11.

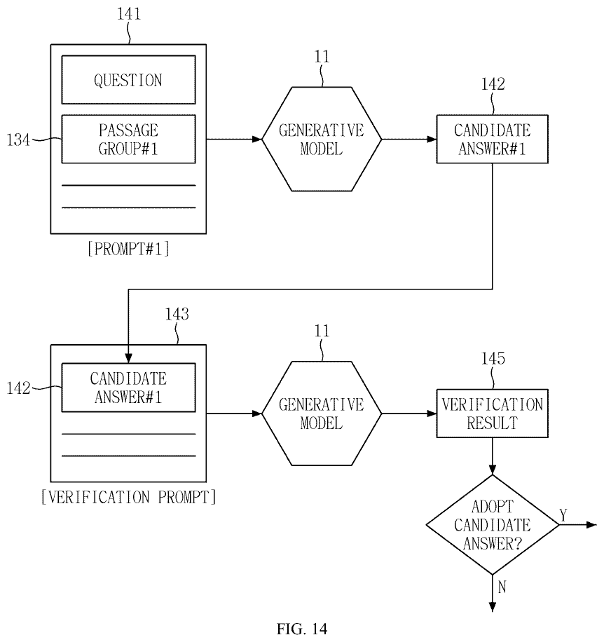

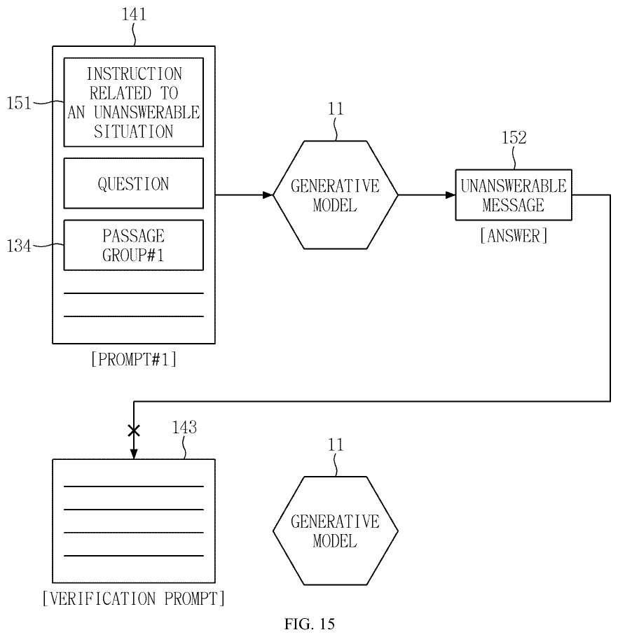

In S124, the generated candidate answer is verified. Such a verification process may be understood as a process of preventing a hallucination problem of the generative model 11 and increasing accuracy of the answer. For example, the system 10 may verify the candidate answer through the generative model 11, and such an example will be described in more detail below with reference to FIGS. 14 and 15.

FIGS. 14 and 15 are illustrative diagrams for describing S124 in detail. FIGS. 14 and 15 assume a case where passage expansion (see FIG. 13) is performed and illustrate a case where verification for a first candidate answer 142 is performed.

As illustrated in FIG. 14, assume that a candidate answer 142 is generated from a prompt 141 through the generative model 11. In such a case, the system 10 may generate a verification prompt 143 for verifying the candidate answer 142. Since the verification prompt 143 includes only the candidate answer 142 and an instruction (e.g., an instruction requesting verification), the number of tokens in the verification prompt 143 is considerably smaller than the numbers of tokens of other prompts. Accordingly, even though the generative model 11 is used, verification for the candidate answer 142 may be quickly performed.

Next, the system 10 may obtain a verification result 145 for the candidate answer 142 by inputting the verification prompt 143 to the generative model 11. When the verification result 145 indicates that the candidate answer 142 is valid, the system 10 may adopt the candidate answer 142 as an answer to the question. Otherwise, the system 10 may reject the candidate answer 142.

In some exemplary embodiments, as illustrated in FIG. 15, the verification prompt 143 may further include an instruction 151 related to an unanswerable situation. The instruction 151 may be an instruction requesting that a specific message (e.g., “I don't know”, etc.) is output when the unanswerable situation occurs (e.g., when the generative model 11 does not know the answer to the question). In such a case, the system 10 may inspect whether or not the specific message exists in a candidate answer 152, and verification for the candidate answer 152 may be suspended (because contents to be verified do not exist) when the specific message exists in the candidate answer 152. Otherwise, the system 10 may perform the verification for the candidate answer (e.g., 142).

A description will be provided with reference to FIG. 12 again.

In S125, it is decided whether or not the number of valid candidate answers has reached a preset number. Here, the number of candidate answers may be set by the user or may be a setting value of the system 10.

When the number of valid candidate answers reaches the preset number, the system 10 may end an entire answer generation process even though a remaining common passage exists (i.e., a candidate answer generation process for the remaining common passage is suspended). In addition, the system 10 may provide the valid candidate answers (e.g., multiple valid candidate answers) generated so far as answers to the question of the user.

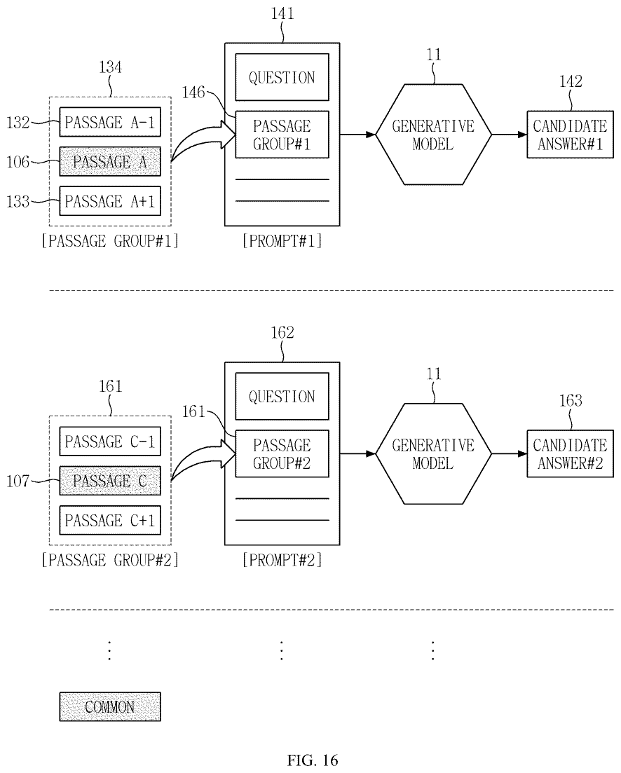

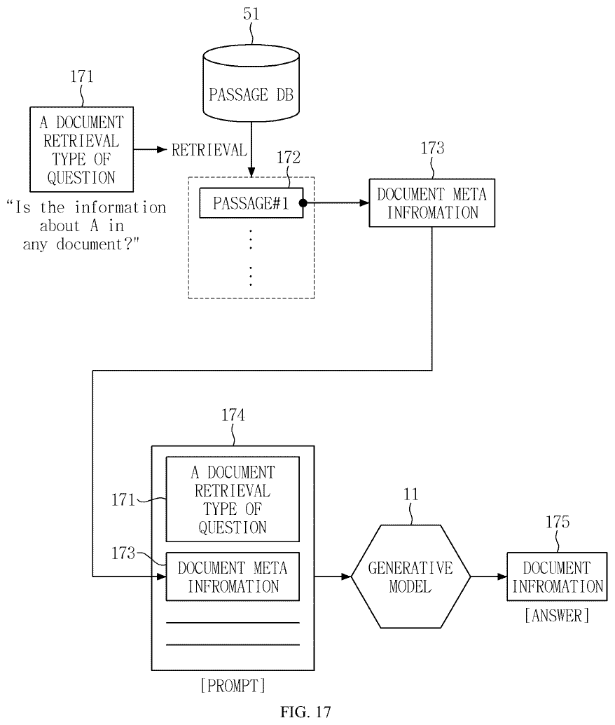

Otherwise, the system 10 may repeatedly perform S121 to S125 on another common passage. For example, as illustrated in FIG. 16, the system 10 may configure a passage group 161 by performing passage expansion on another common passage 107, and generate another prompt 162 based on the passage group 161. Next, the system 10 may generate another candidate answer 163 by inputting the prompt 162 to the generative model 11.

So far, the answer generation method according to some exemplary embodiments of the present disclosure has been described with reference to FIGS. 9 to 16. According to that described above, the first candidate passage set may be obtained by retrieving the knowledge base 21 using the first embedding model 101, and the second candidate passage set may be obtained by retrieving the knowledge base 21 using the second embedding model 102. In addition, one or more common passages may be extracted from the first candidate passage set and the second candidate passage set, and the answer to the question of the user may be generated from the one or more common passages through the generative model. In such a case, the passage associated with the question may be more accurately retrieved, and consequently, the answer to the question may also be more accurately generated. Furthermore, as the number of retrieved passages (i.e., common passages) is reduced, a computing cost required for answer generation is reduced and an answer speed to the question may be improved.

In addition, the first embedding model 101 may be constructed through the training based on the text sample pair whose length difference is less than the reference value, and the second embedding model 102 may be constructed through the training based on the text sample pair whose length difference is the reference value or more. In such a case, even when passages having various lengths exist in the knowledge base 21 (i.e., the passage DB 51), passages associated with the question may be accurately retrieved.

In addition, the prompt for generating the answer may be generated (configured) by further using surrounding passages of the common passage in addition to the common passage (or a general passage). In such a case, the probability that the information (e.g., the correct answer) associated with the question will be included in the prompt may increase, and even when the information spans several passages, the answer may be accurately generated.

In addition, multiple prompts may be generated using multiple common passages (or general passages), and multiple candidate answers may be generated using the multiple prompts. In such a case, a rich answer to the question may be easily provided to the user.

Hereinafter, an answer generation method according to some other exemplary embodiments of the present disclosure will be described with reference to FIG. 17.

As illustrated in FIG. 17, the present exemplary embodiments relate to a method of generating an answer to a document retrieval type of question 171. For example, a question requests retrieval of a document related to specific information (e.g., a question inquiring a document that is a source of information) may be such a type of question 171, but the scope of the present disclosure is not limited thereto.

When the question 171 corresponding to a document retrieval type is received, the system 10 may obtain passages (e.g., 172) associated with the question 171 (the passage 172 may be a common passage) by retrieving the passage DB 51 using the question 171 (e.g., the preprocessed question). In this case, the system 10 may also obtain meta information (e.g., 173) of a document to which each of the passages (e.g., 172) belongs.

Next, the system 10 may derive (generate) information 175 of a document related to specific information specified in the question 171 by generating (configuring) a prompt 174 based on the question 171 and the meta information (e.g., 173) and inputting the prompt 174 to the generative model 11. Here, it may be understood that the reason why the meta information (e.g., 173) of the document is added to the prompt 174 is that the meta information (e.g., 173) of the document is more helpful than contents of the passage (e.g., 172) in solving the document retrieval type of question 171. In some cases, the system 10 may also add the passage (e.g., 172) to the prompt 174.

The document information 175 may be, for example, a title, a writer, a location, and the like, of the document, but the scope of the present disclosure is not limited thereto.

So far, the answer generation method according to some other exemplary embodiments of the present disclosure has been described with reference to FIG. 17. According to that described above, by including the meta information of the document to which the passage associated with the question belongs in the prompt, an answer to the document retrieval type of question (e.g., a question requesting the retrieval of a document that is a source of a specific document) may also be accurately generated through the generative model 11.

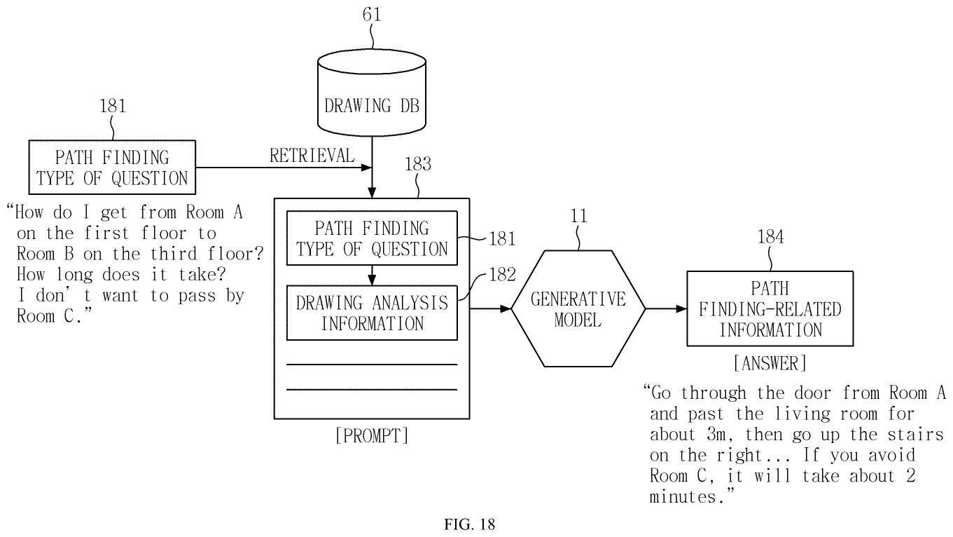

Hereinafter, an answer generation method according to some other exemplary embodiments of the present disclosure will be described with reference to FIG. 18.

As illustrated in FIG. 18, the present exemplary embodiments relate to a method of generating an answer to a path finding type of question 181. For example, a question inquiring a path, time taken, and the like, from a departure point (e.g., a specific point, a specific zone, etc.) to a destination may be such a type of question 181, but the scope of the present disclosure is not limited thereto.

When the question 181 corresponding to a path finding type is received, the system 10 may obtain drawing analysis information 182 associated with the question 181 by retrieving the drawing DB 61 using the question 181 (e.g., the preprocessed question). For example, the system 10 may obtain the drawing analysis information 182 associated with the question 181 by retrieving the drawing DB 61 using space (place)-related words specified in the question 181, but the scope of the present disclosure is not limited thereto. As described above, the drawing analysis information 182 may include location information of space elements, path information between the space elements, and the like.

Next, the system 10 may derive path finding-related information 184 (e.g., a path, time taken, etc.) for the question 181 by generating (configuring) a prompt 183 based on the question 181 and the drawing analysis information 182 and inputting the prompt 183 to the generative model 11. The generative model 11 may accurately derive the path finding-related information 184 requested by the user by sufficiently understanding information on a space (place) specified in the question 181 through the drawing analysis information 182.

For reference, when the question 181 inquires a path (e.g., a shortest path) existing in the drawing analysis information 182, the system 10 may provide path information using the drawing analysis information 182 without using the generative model 11.

So far, the answer generation method according to some other exemplary embodiments of the present disclosure has been described with reference to FIG. 18. According to that described above, by including the drawing analysis information (e.g., the location information of the space elements and the path information between the space elements, etc.) generated by analyzing the drawing image in the prompt, an answer to the path finding type of question may also be accurately generated through the generative model 11.

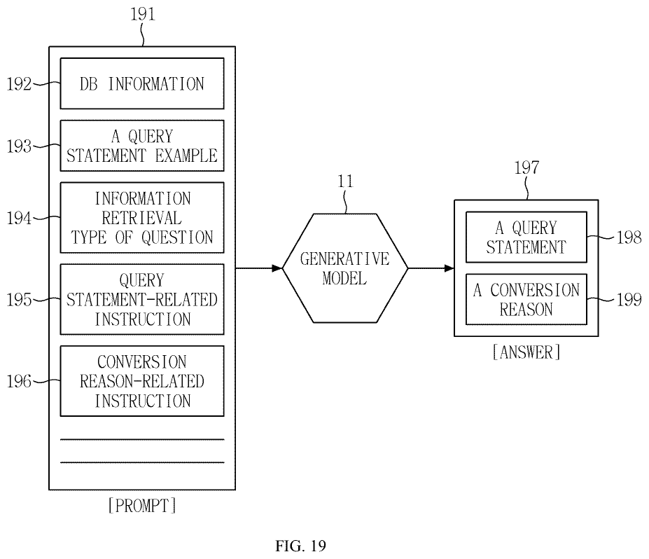

Hereinafter, an answer generation method according to some other exemplary embodiments of the present disclosure will be described with reference to FIG. 19.

As illustrated in FIG. 19, the present exemplary embodiments relate to a method of generating an answer to an information retrieval type of question 194. For example, a question requests retrieval of information stored in a specific DB may be such a type of question 194, but the scope of the present disclosure is not limited thereto.

When the question 194 corresponding to an information retrieval type is received, the system 10 may generate an answer to the question 194 by converting the question 194 (e.g., the preprocessed question) into a query statement 198 through the generative model 11 and retrieving the specific DB using the query statement 198.

Specifically, the system 10 may determine a DB that is a retrieval target by analyzing the question 194. A method of determining the DB may be any method (e.g., a method of using the generative model 11, etc.).

Next, the system 10 may obtain a prompt 191 (or a prompt template) corresponding to the determined DB. For example, the system 10 may obtain a prompt 191 corresponding to the above-described DB among prompts for each predefined DB. As illustrated in FIG. 19, DB information 192, a query statement example 193, a query statement-related instruction 195, a conversion reason-related instruction 196, and the like, may be predefined (included) in the prompt 191.

The DB information 192 may include information on a table and a field (e.g., a table name, a field name, etc.) in a DB.

The query statement example 193 may include a user question sample and a query statement sample (i.e., a correct answer query statement sample) corresponding to the user question sample. In addition, the query statement example 193 may further include an explanation for the reason why the user question sample is converted into the query statement sample. The number of query statement examples 193 may be set to any number. The query statement example 193 may serve to improve accuracy of query statement conversion by providing reference information for the query statement conversion.

The query statement-related instruction 195 refers to an instruction requesting that the question 194 is to be converted into the query statement.

The conversion reason-related instruction 196 refers to an instruction requesting an explanation for the reason why the question 194 is converted into the query statement 198. Such an instruction 196 may improve accuracy of query statement conversion by forcing the generative model 11 to explain the reason why the query statement 198 is generated.

Next, the system 10 may complete the prompt 191 by adding the received question 194 to the prompt 191, and convert the question 194 into the query statement 198 by inputting the completed prompt 191 to the generative model 11. In some cases, the system 10 may retrieve query statement examples associated with the question 194 in a query statement example DB using the question 194 (e.g., vector similarity-based retrieval) and add the retrieved query statement examples to the prompt 191.

As illustrated in FIG. 19, an answer 197 output by the generative model 11 may further include an explanation 199 for the reason why the generative model 11 has generated the query statement 198 in this way, in addition to the query statement 198.

Next, the system 10 may generate an answer to the question 194 by retrieving specific information in the specific DB through the query statement 198.

Meanwhile, when the retrieval of the DB according to the query statement 198 is unsuccessful, the system 10 may generate an answer to the question 194 according to a method of processing a general type of question. For example, the system 10 may obtain a passage associated with the question 194 by retrieving the passage DB 51 using the question 194 and generate an additional prompt based on the question 194 and the passage associated with the question 194. Next, the system 10 may generate an answer to the question 194 by inputting the additional prompt to the generative model 11. In this way, a case where an unanswerable message is transferred to the user may be minimized.

So far, the answer generation method according to some other exemplary embodiments of the present disclosure has been described with reference to FIG. 19. According to that described above, by converting the information retrieval type of question (e.g., a question requesting the retrieval of the specific information) into the query statement through the generative model 11 and retrieving the specific DB using the query statement, an answer to the information retrieval type of question may also be accurately generated.

So far, the methods of generating answers to various types of questions have been described in detail with reference to FIGS. 9 to 19. Hereinafter, an illustrative computing device 200 capable of implementing the above-described system 10 will be described.

FIG. 20 is an illustrative hardware configuration diagram illustrating a computing device 200.

As illustrated in FIG. 20, the computing device 200 may include one or more processors 201, a bus 203, a communication interface 204, a memory 202 loading a computer program 206 executed by the processor 201, and a storage 205 storing the computer program 206. However, only components related to an exemplary embodiment of the present disclosure are illustrated in FIG. 20. Accordingly, one of ordinary skill in the art to which the present disclosure pertains may know that the computing system 200 may further include other general-purpose components in addition to the components illustrated in FIG. 20. That is, the computing device 200 may further include various components in addition to the components illustrated in FIG. 20. In addition, in some cases, the computing device 200 may be configured in a form in which some of the components illustrated in FIG. 20 are omitted. Hereinafter, respective components of the computing device 200 will be described.

The processor 201 may control overall operations of the respective components of the computing device 200. The processor 201 may be configured to include at least one of a central processing unit (CPU), a micro processor unit (MPU), a micro controller unit (MCU), a graphic processing unit (GPU), or any type of processor well known in the art to which the present disclosure pertains. In addition, the processor 201 may perform an arithmetic operation on at least one application or computer program in order to execute specific steps/operations/methods. The computing device 200 may include one or more processors.

Next, the memory 202 may store various data, commands, and/or information. The memory 202 may load the computer program 206 from the storage 205 in order to execute the specific steps/operations/methods. The memory 202 may be implemented as a volatile memory such as a random access memory (RAM), but the technical scope of the present disclosure is not limited thereto.

Next, the bus 203 may provide a communication function between the components of the computing device 200. The bus 203 may be implemented as various types of buses such as an address bus, a data bus, and a control bus.

Next, the communication interface 204 may support wired/wireless Internet communication of the computing device 200. In addition, the communication interface 204 may support various communication methods other than the Internet communication. To this end, the communication interface 204 may be configured to include a communication module well known in the art to which the present disclosure pertains.

Next, the storage 205 may non-temporarily store one or more computer programs 206. The storage 205 may be configured to include a nonvolatile memory such as a read only memory (ROM), an erasable programmable (EPROM), an electrically erasable programmable ROM (EEPROM), or a flash memory, a hard disk, a removable disk, or any type of computer-readable recording medium well known in the art to which the present disclosure pertains.

Next, the computer program 206 may include instructions for causing the processor 201 to perform the specific steps/operations/methods when they are loaded into the memory 202. That is, the processor 201 may perform the specific steps/operations/methods by executing the instructions loaded into the memory 202.

As an example, a computer program 206 may include instructions for performing an operation of preprocessing a question of a user, an operation of obtaining a first candidate passage set associated with the preprocessed question by retrieving a knowledge base 21 using a first embedding model 101, an operation of obtaining a second candidate passage set associated with the preprocessed question by retrieving the knowledge base 21 using a second embedding model 102, an operation of extracting one or more common passages from the first candidate passage set and the second candidate passage set, and an operation of generating an answer to the preprocessed question from the one or more common passages through a generative model 11.

As another example, the computer program 206 may include instructions for performing at least some of the steps/operations/methods described with reference to FIGS. 1 to 19.

In such a case, the system 10 according to some exemplary embodiments of the present disclosure may be implemented through the computing device 200.

Meanwhile, in some exemplary embodiments, the computing device 200 illustrated in FIG. 20 may also refer to a virtual machine implemented based on a cloud technology. For example, the computing device 200 may be a virtual machine operating on one or more physical servers included in a server farm. In this case, at least some of the processor 201, the memory 202, and the storage 205 illustrated in FIG. 20 may be virtual hardware, and the communication interface 204 may also be implemented as a virtualized networking element such as a virtual switch.

So far, various embodiments of the present disclosure and effects according to the embodiments have been described with reference to FIGS. 1 to 20. The effects according to the technical idea of the present disclosure are not limited to the effects mentioned above, and other effects that are not mentioned may be obviously understood by those skilled in the art from the following description.

Furthermore, although a plurality of components are described as being combined or operating in combination in the above embodiments, the technical ideas of the present disclosure are not necessarily limited to these embodiments, i.e., any of the components may optionally be combined in one or more combinations, provided that the technical ideas of the present disclosure are within the scope of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation. The scope of protection of the present invention should be interpreted in accordance with the claims below, and all technical ideas within the equivalent scope should be construed as being included in the scope of rights of the technical ideas defined by this disclosure.

What is claimed is:

1. A question answering system comprising:
one or more processors; and
a memory storing one or more computer programs executed by the one or more processors,
wherein the one or more computer programs include instructions for:
an operation of preprocessing a question of a user;
an operation of obtaining a first candidate passage set associated with the preprocessed question by retrieving a knowledge base using a first embedding model;
an operation of obtaining a second candidate passage set associated with the preprocessed question by retrieving the knowledge base using a second embedding model;
an operation of extracting one or more common passages from the first candidate passage set and the second candidate passage set; and
an operation of generating an answer to the preprocessed question from the one or more common passages through a generative model.

2. The question answering system of claim 1, wherein the first embedding model is trained using a text sample pair whose length difference is less than a reference value, and
the second embedding model is trained using a text sample pair whose length difference is the reference value or more.

3. The question answering system of claim 1, wherein the operation of preprocessing the question includes:
an operation of generating a prompt for augmenting the question based on a question answering history of the user and the question; and
an operation of augmenting the question by inputting the prompt to a specific generative model.

4. The question answering system of claim 1, wherein the operation of generating the answer to the preprocessed question includes:
an operation of obtaining surrounding passages associated with a first common passage of the one or more common passages, the surrounding passages being passages located around the first common passage in a document to which the first common passage belongs; and
an operation of generating the answer to the preprocessed question by including the first common passage and the surrounding passages in the same prompt.

5. The question answering system of claim 1, wherein the one or more common passages include a first common passage and a second common passage, and
the operation of generating the answer to the preprocessed question includes:
an operation of generating a first prompt based on the preprocessed question and the first common passage;
an operation of generating a first candidate answer to the preprocessed question by inputting the first prompt to the generative model;
an operation of generating a second prompt based on the preprocessed question and the second common passage; and
an operation of generating a second candidate answer to the preprocessed question by inputting the second prompt to the generative model.

6. The question answering system of claim 1, wherein the operation of generating the answer to the preprocessed question includes:
an operation of generating a candidate answer to the preprocessed question by inputting a prompt generated based on the preprocessed question to the generative model;
an operation of generating a verification prompt for verifying the candidate answer;
an operation of verifying the candidate answer by inputting the verification prompt to a specific generative model; and
an operation of providing the candidate answer as the answer to the preprocessed question based on a verification result.

7. The question answering system of claim 1, wherein the knowledge base includes a drawing database (DB), and
the one or more computer programs further include instructions for:
an operation of receiving another question related to path finding;
an operation of obtaining analysis information of a drawing associated with the another question by retrieving the drawing DB using the another question, the analysis information including location information of elements of a space represented by the drawing and path information between the elements;
an operation of generating a prompt based on the another question and the analysis information; and
an operation of deriving information related to the path finding by inputting the prompt to the generative model.

8. The question answering system of claim 1, wherein the one or more computer programs further include instructions for:
an operation of receiving another question retrieving a document related to specific information;
an operation of obtaining a passage associated with the another question by retrieving the knowledge base using the another question;
an operation of generating a prompt based on meta information of a document to which the another question and the obtained passage belong; and
an operation of deriving information of the document related to the specific information by inputting the prompt to the generative model.

9. The question answering system of claim 1, wherein the knowledge base includes a database (DB) supporting query statement-based retrieval and a passage DB, and
the one or more computer programs include further instructions for
an operation of receiving another question requesting retrieval of specific information;
an operation of generating a prompt for converting the another question into a specific query statement based on the another question, information of the DB, and a query statement example, the query statement example including a user question sample and a query statement sample corresponding to the user question sample;
an operation of converting the another question into the specific query statement by inputting the prompt to the generative model; and
an operation of retrieving the DB using the specific query statement.

10. The question answering system of claim 9, wherein the one or more computer programs further include instructions for:
an operation of obtaining a passage associated with the another question by retrieving the passage DB using another question when the retrieval of the DB according to the specific query statement is unsuccessful;
an operation of generating an additional prompt based on the another question and the obtained passage; and
an operation of generating an answer to the another question by inputting the additional prompt to the generative model.

11. A question answering method performed by at least one processor, comprising:
preprocessing a question of a user;
obtaining a first candidate passage set associated with the preprocessed question by retrieving a knowledge base using a first embedding model;
obtaining a second candidate passage set associated with the preprocessed question by retrieving the knowledge base using a second embedding model;
extracting one or more common passages from the first candidate passage set and the second candidate passage set; and
generating an answer to the preprocessed question from the one or more common passages through a generative model.

12. The question answering method of claim 11, wherein the first embedding model is trained using a text sample pair whose length difference is less than a reference value, and
the second embedding model is trained using a text sample pair whose length difference is the reference value or more.

13. The question answering method of claim 11, wherein the preprocessing of the question includes:
generating a prompt for augmenting the question based on a question answering history of the user and the question; and
augmenting the question by inputting the prompt to a specific generative model.

14. The question answering method of claim 11, wherein the generating of the answer to the preprocessed question includes:
obtaining surrounding passages associated with a first common passage of the one or more common passages, the surrounding passages being passages located around the first common passage in a document to which the first common passage belongs; and
generating the answer to the preprocessed question by including the first common passage and the surrounding passages in the same prompt.

15. The question answering method of claim 11, wherein the one or more common passages include a first common passage and a second common passage, and
the generating of the answer to the preprocessed question includes:
generating a first prompt based on the preprocessed question and the first common passage;
generating a first candidate answer to the preprocessed question by inputting the first prompt to the generative model;
generating a second prompt based on the preprocessed question and the second common passage; and
generating a second candidate answer to the preprocessed question by inputting the second prompt to the generative model.

16. The question answering method of claim 11, wherein the generating of the answer to the preprocessed question includes:
generating a candidate answer to the preprocessed question by inputting a prompt generated based on the preprocessed question to the generative model;
generating a verification prompt for verifying the candidate answer;
verifying the candidate answer by inputting the verification prompt to a specific generative model; and
providing the candidate answer as the answer to the preprocessed question based on a verification result.

17. The question answering method of claim 11, wherein the knowledge base includes a drawing database (DB), and
the question answering method further comprises:
receiving another question related to path finding;
obtaining analysis information of a drawing associated with the another question by retrieving the drawing DB using the another question, the analysis information including location information of elements of a space represented by the drawing and path information between the elements;
generating a prompt based on the another question and the analysis information; and
deriving information related to the path finding by inputting the prompt to the generative model.

18. The question answering method of claim 11, further comprising:
receiving another question retrieving a document related to specific information;
obtaining a passage associated with the another question by retrieving the knowledge base using the another question;
generating a prompt based on meta information of a document to which the another question and the obtained passage belong; and
deriving information of the document related to the specific information by inputting the prompt to the generative model.

19. The question answering method of claim 11, wherein the knowledge base includes a database (DB) supporting query statement-based retrieval and a passage DB, and
the question answering method further comprises:
receiving another question requesting retrieval of specific information;
generating a prompt for converting the another question into a specific query statement based on the another question, information of the DB, and a query statement example, the query statement example including a user question sample and a query statement sample corresponding to the user question sample;
converting the another question into the specific query statement by inputting the prompt to the generative model; and
retrieving the DB using the specific query statement.

20. A non-transitory computer-readable recording medium storing a computer program executable by a processor of a computer to execute:
preprocessing a question of a user;
obtaining a first candidate passage set associated with the preprocessed question by retrieving a knowledge base using a first embedding model;
obtaining a second candidate passage set associated with the preprocessed question by retrieving the knowledge base using a second embedding model;
extracting one or more common passages from the first candidate passage set and the second candidate passage set; and
generating an answer to the preprocessed question from the one or more common passages through a generative model.
